(19) United States
(12) Patent Application Publication
(10) Pub. No.: US 2012/0268346 A1
(43) Pub. Date: Oct. 25, 2012

(54) BIOLOGICALLY INSPIRED BEAM FORMING SMALL ANTENNA ARRAYS

(75) Inventor: Leah WANG, Fremont, CA (US)

(73) Assignee: LOCKHEED MARTIN CORPORATION, Bethesda, MD (US)

(21) Appl. No.: 13/436,746

(22) Filed: Mar. 30, 2012

Related U.S. Application Data
(60) Provisional application No. 61/478,895, filed on Apr. 25, 2011.

(51) Int. Cl. H01Q 21/00

(52) U.S. Cl. 343/893

(57) ABSTRACT

An apparatus for electromagnetic beam forming by using electrically small antenna (ESA) elements may comprise an excitation antenna including a feed section coupled to a circuit. The apparatus may also comprise at least two closely spaced ESAs adapted to electromagnetically couple to the excitation antenna. The excitation antenna may be operable to generate an electromagnetic field that couples to the at least two ESAs. The electromagnetic field may be created as a result of a current generated by the induction coupling. Narrow beam forming can be achieved by adopting certain inter-coupling profiles along neighboring ESA elements.

### CROSS-REFERENCE TO RELATED APPLICATIONS

This application claims the benefit of priority under 35 U.S.C. §119 from U.S. Provisional Patent Application 61/478,895 filed Apr. 25, 2011, which is incorporated herein by reference in its entirety.

### STATEMENT REGARDING FEDERALLY SPONSORED RESEARCH OR DEVELOPMENT

Not applicable.

### FIELD OF THE INVENTION

The present invention generally relates to beam forming, and more particularly to biologically inspired beam forming small antenna arrays.

### BACKGROUND

Localization of sources and targets with high accuracy may be especially critical to many applications, for example, military applications. Those applications may require antenna phased arrays with high radiation performance such as highly directed, narrow half-power beam width, and low level of sidelobe. Conventional antenna phased arrays may rely on inter-elemental time delay of antenna arrays to control beam pattern characteristics of the antenna arrays. The beam forming capability may be directly proportional to the size of the array's electrical aperture. Typically half-a-wavelength inter-element spacing may be required in conventional phased arrays. For high performance arrays, the number of elements required can be very large thus the size of the arrays may become overwhelming.

For tactical and mobile applications, most military sensing systems may be confined to small space and light weight, thus requiring small sized arrays. As discussed above, small size arrays based on conventional design approach may suffer significant performance degradations in their radiation performance because of reduced electrical aperture.

As a result, there is a need for design concepts for small size arrays with high radiation performance.

### SUMMARY

In some aspects, an apparatus for electromagnetic beam forming using electrically small antenna (ESA) elements is described. The apparatus may comprise an excitation antenna including a feed section coupled to a feed circuit. The apparatus may also comprise at least two ESAs adapted to electromagnetically couple to the excitation antenna via induction. The ESAs may be very closely spaced from one another. The excitation antenna may be operable to generate an electromagnetic field that couples to at least two ESAs. The electromagnetic field may be created as a result of a current generated by the induction coupling.

In another aspect, a method for electromagnetic beam forming using ESA elements is described. The method may comprise coupling an excitation antenna including a feed section to the ESA elements. The excitation antenna may be operated to generate an electromagnetic field. At least two ESAs may be adapted to couple the electromagnetic field generated by the excitation antenna. The electromagnetic field may be created as a result of a current generated by the induction coupling.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific aspects of the disclosure, wherein:

FIGS. 1A-1C are diagrams illustrating coupling mechanism between ears of an Ormia and the corresponding response functions.

FIGS. 2A-2C are conceptual diagrams illustrating examples of one, two and three dimensional electrically small antenna (ESA) arrays used for beam forming, according to certain aspects;

FIGS. 3A-3C show a table illustrating example design parameters for a one-dimensional beam forming ESA array, design configurations, and response functions, according to certain aspects;

FIGS. 4A-4C show diagrams illustrating radiation patterns in 3D and 2D plots for one and two dimensional beam forming ESA arrays, according to certain aspects;

FIGS. 5A-5B are diagrams illustrating a conventional patch array and corresponding radiation pattern, in 3D and 2D plots, as compared with an example two dimensional ESA, according to certain aspects;

FIGS. 6A-6B are diagrams illustrating example active beam forming with multiple excitation antennas, according to certain aspects; and

FIG. 7 is a flow diagram illustrating an example method for electromagnetic beam forming, according to certain aspects.

### DETAILED DESCRIPTION

The present disclosure is directed, in part, to an apparatus for electromagnetic beam forming using electrically small antenna (ESA) elements is described. The apparatus may comprise an excitation antenna including a feed section coupled to a feed circuit. The apparatus may also comprise at least two ESAs adapted to electromagnetically couple to the excitation antenna. The excitation antenna may be operable to generate an electromagnetic field that couples to the at least two ESAs. The electromagnetic field may be created as a result of a current generated by the induction coupling.

According to various aspects of the subject technology, a novel design technique that overcomes the size limitation of standard antenna arrays is disclosed. The disclosure demonstrates that a small size array with much smaller inter-element spacing and much reduced footprint (e.g., 50 times or more reduction) can have as high a radiation performance as a large size array may have.

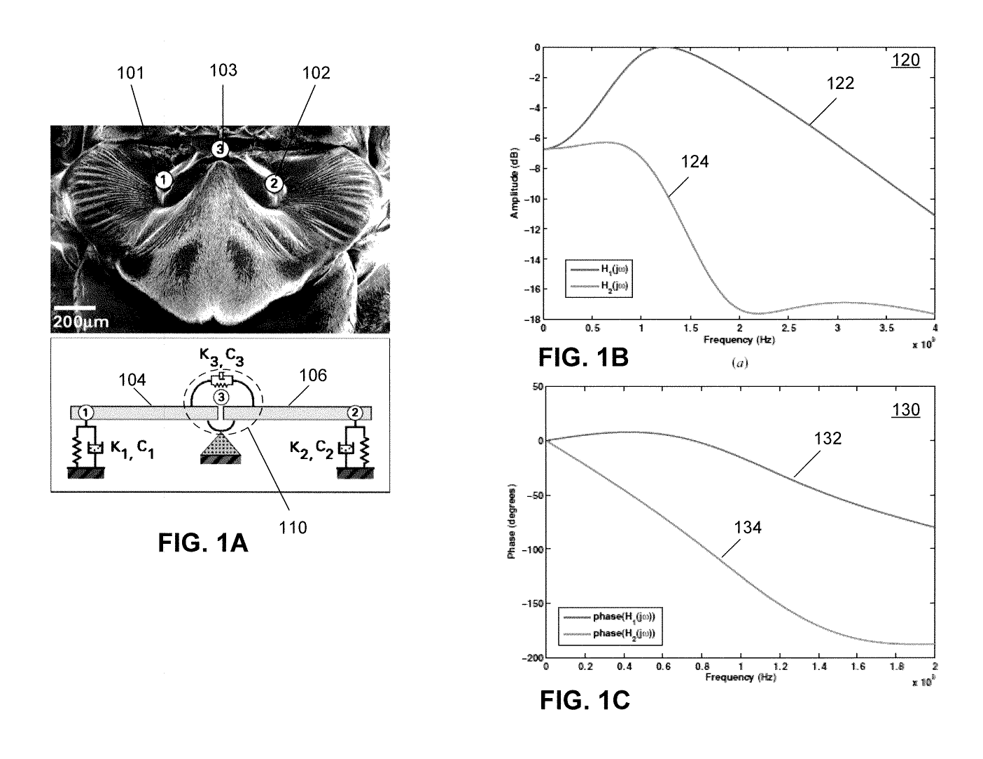

According to various aspects of the subject technology, the disclosed approach may be biologically inspired by the remarkable hearing capability in a parasitoid tachinid fly called Ormia ochracea (hereinafter “Ormia”). A female Ormia can locate crickets very accurately using two-ear cues (see 101 and 102 in FIG. 1A) despite significant mismatch between the wavelength of the cricket's call (e.g., 7 cm) and the distance between Ormia's ears (e.g., 1.2 mm). One may consider the two ears of Ormia as very closely spaced antenna arrays which generate cues too small to be detectable at target wavelength. The Ormia's capability to detect signals accurately and clearly may involve mechanisms different from those in conventional antenna arrays. Experimental biology research explains that the Ormia's localization ability arises from a mechanical coupling mechanism between its ears.

In the equivalent mechanical system as shown in FIG. 1A, the inter-tympanal bridge (see 103 in FIG. 1A) may be assumed to consist of two rigid bars 104 and 106 connected at a pivot 110 through a coupling spring and dashpot. The springs and dashpots located at the extreme ends of the bridge may approximate the dynamic properties of sensing structures in the Ormia's two ears. Under the coupling mechanism, the closely spaced ears behave like virtual ears with much larger spacing between them.

FIG. 1B plots a response transfer function 120 of ears 101 and 102 showing amplification in amplitude (e.g., plots 122 and 124). FIG. 1C plots a response transfer function 130 of ears 102 and 101 showing amplification in phase (e.g., plots 132 and 134). The response functions may very closely correspond to those of an antenna array with much larger spacing between array elements. One observation here is that the coupling mechanism in Ormia's ears may have transformed a small antenna array into a large virtual antenna array. It is also understood that the asymmetry observed in the response functions 120 and 130 may be a result of the coupling mechanism 103 between ears 101 and 102 of Ormia.

Sets of differential equations governing the coupling effect in Ormia's ears are well studied and precisely known. The same coupling function may be mathematically applied to an array factor of a closely spaced linear dipole array (e.g., with 0.1λ spacing, where λ is the operating wavelength). It can be demonstrated that applying such a coupling function to the array factor may lead to a high-quality beam &lining capability. However, design approaches that can realize such a coupling mechanism in practical arrays are not known and are the subject of the present disclosure.

According to various aspects of the subject technology, the disclosed design approaches for small size antenna arrays can realize similar coupling mechanism as found in Ormia's ears. With similar coupling mechanism physically implemented in the present disclosure, it is demonstrate that small-size antenna arrays with remarkable beam forming capabilities can be realized in practice. The present biologically inspired design approaches may overcome the size limitations of many conventional antenna arrays and can therefore enable a variety of applications that may desperately require compact size and lightweight arrays with high radiation performance.

According to various aspects of the subject technology, an array of closely coupled ESAs are disclosed. Each antenna element of the ESA may be in the form of a split-ring-resonator (SRR), which includes a ring resonator with a gap. It is understood that a ring resonator without a gap may not be able to radiate electromagnetic waves. Each SRR may be considered as an ESA because the SRR resonates at a much lower frequency than that the resonance frequency corresponding to the SRR's dimension (e.g., a diameter). A typical SRR may have a dimension (e.g., diameter) of approximately λ/20, λ represent the operating wavelength (i.e., a wavelength corresponding to the resonance frequency of the SRR). In the following any reference to SRR is to be considered as a reference to an ESA SRR and “SRR array” and “ESA array” may be inter-changeably used.

A resonance of a SRR is mainly determined by an inductance (L) and a capacitance (C) of the SRR, as in a tank circuit. Coupling between any two adjacent SRRs may depend on a number of parameters including the separation distance between the adjacent SRRs and the respective loading Cs and Ls. The coupling factor can be tuned over a large range by tuning the parameters while keeping the resonance frequency the same.

The coupling mechanism between SRRs may work similar to the coupling between two parallel LC loaded transmission lines, where the coupling factor is a function of transmission lines spacing and the corresponding loading L and C for each transmission line. By tuning the coupling amplitudes and phases among adjacent SRR pairs, the resulting response function from the SRR coupling can be engineered to mimic or match the response function governing Ormia's ears. Detailed derivation formulas are presented herein.

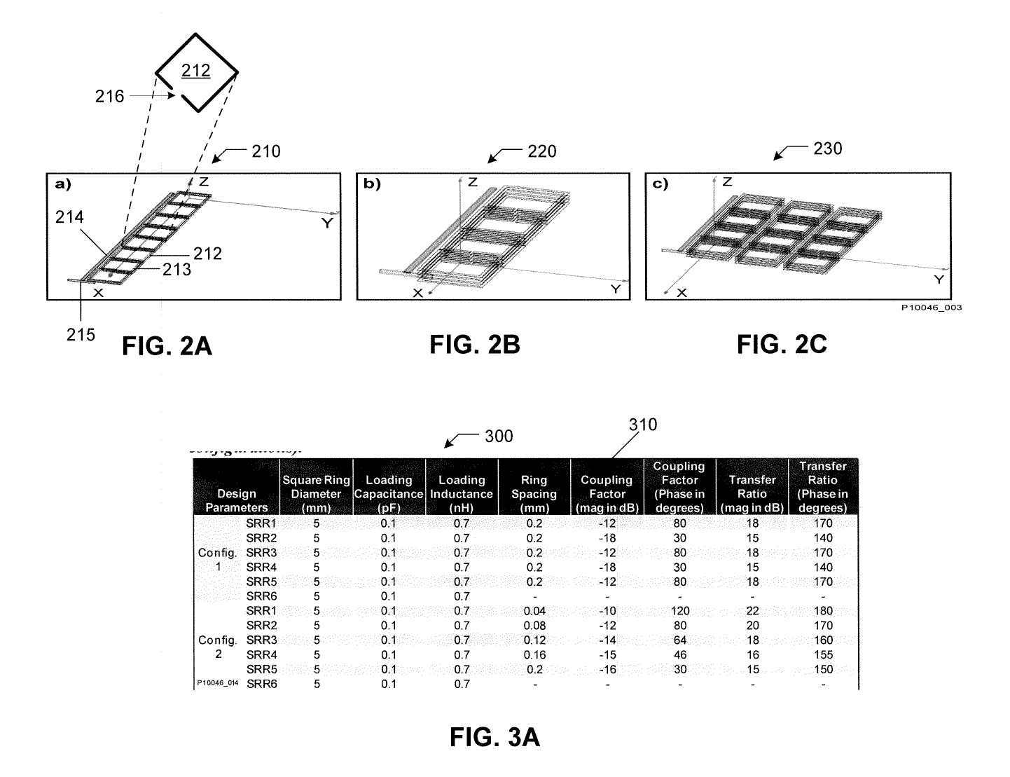

FIGS. 2A-2C are conceptual diagrams illustrating examples of one, two and three-dimensional ESA arrays 210, 220, and 230 used for beam forming, according to certain aspects. One-dimensional ESA array 210 includes a number of ESA elements 212 (and 213), an excitation antenna 214 with a feeder 215. Each ESA 212 may comprise a SRR made of a ring made of an electrically conducting material that includes a slit 216 with a predetermined gap (e.g., a few mm). The SRR may be formed as a flat square, rectangular or circular ring. The diameter of the ring may be selected to be a predetermined fraction (e.g., five per cent) of the wavelength corresponding to the resonance frequency of the SRR.

The ESA elements 212 may be operable to provide electromagnetic inter-coupling between two adjacent ESAs. The spacing between the ESAs may be less than, for example, 0.5 mm. The electromagnetic inter-coupling may depend on a number of parameters including the distance between the two adjacent ESAs, and loading capacitances and loading inductances. Excitation antenna 214 may be used to excite the antenna elements (e.g., ESA elements 212). Excitation antenna 214 may couple to an external circuit via the feeder 215. Alternatively, each element or a group of elements can be excited separately for active beam forming, as discussed in more detail herein.

FIG. 2B show a two-dimensional ESA array 220, where the second dimension along the Z axis is provided by a number of one-dimensional ESA arrays similar to ESA array 210. FIG. 2C show a three-dimensional ESA array 230, where the additional third dimension along the Y axis is provided by a number of two-dimensional ESA arrays similar to ESA array 220. In the following analysis, for simplicity, beam forming characteristics of various designs are demonstrated as transmitter ESA arrays. By the reciprocity nature of the derivations, the disclosed designs also holds for receiving ESA arrays.

The closely coupled SRR arrays can be analyzed by introducing coupling effects to the analysis performed for phased arrays:

$$AF ( θ ) = {\sum }_{m = 1}^{M} {I}_{m} exp ( - j ( m - 1 ) ( kd sin θ + β ) )$$

$$\begin{matrix}{I}_{m} —current in each array element \\ d —element spacing \\ β—excitation phase\end{matrix}$$

$${I}_{m} = {\sum }_{n = 1}^{N} {I}_{m , n} = {I}_{m 0} {\sum }_{n = 1}^{N} {C}_{m , n} exp ( j ω {L}_{m , n} - \frac{1}{j ω {c}_{m , n}} )$$

$$\begin{matrix}{I}_{m 0} —excitation current in each SRR \\ {L}_{m , n} —mutual inductance from nearest neighbors \\ {c}_{m , n} —mutual capacitance from nearest neighbors\end{matrix}$$

Where AF(θ) represents the known normalized array factor as a function of azimuth angle θ. The total current Iₘ in each SRR may consist of excitation current and inductive currents from its nearest neighbors. The transfer ratio H taking into account the mutual coupling is then given by:

$$[ \begin{matrix}{I}_{mo} \\ {I}_{no}\end{matrix} ] H = [ \begin{matrix}{I}_{m} \\ {I}_{n}\end{matrix} ] , H = \frac{{I}_{mo} {e}^{jkd sin θ} - {I}_{m 0} {\sum }_{n = 1}^{N} {C}_{m , n} exp ( j ω {L}_{m , n} - \frac{1}{j ω {c}_{m , n}} )}{{I}_{no} - {I}_{n 0} {\sum }_{k = 1}^{N} {C}_{k , n} exp ( j ω {L}_{k , n} - \frac{1}{j ω {c}_{k , n}} ) {e}^{jkd sin θ}}$$

$${I}_{mo} , {I}_{no} —excitation currents in adjacent SRRs m and n$$

The array factor can then be written as:

$$AF ( θ ) = {\sum }_{m = 1}^{M} {{I}_{m 0} [ exp ( - j β ) \frac{{I}_{mo} {e}^{jkd sin θ} - {I}_{m 0} {\sum }_{n = 1}^{N} {C}_{m , n} exp ( j ω {L}_{m , n} - \frac{1}{j ω {c}_{m , n}} )}{{I}_{no} - {I}_{n 0} {\sum }_{k = 1}^{N} {C}_{k , n} exp ( j ω {L}_{k , n} - \frac{1}{j ω {c}_{k , n}} ) {e}^{jkd sin θ}} ]}^{m - 1}$$

$$\begin{matrix}{I}_{m 0} — excitation current in each array element \\ d —element spacing , \\ θ—elevation angle , \\ β—excitation phase\end{matrix}$$

In the scenario of no coupling, Cₘₙ=0, the array factor transforms to that of a normal ESA array without coupling (i.e., made of independent ESA elements) and becomes:

$$AF ( θ ) = {\sum }_{m = 1}^{M} {{I}_{m 0} [ exp ( - j β ) \frac{{e}^{jkd sin θ} - {\sum }_{n = 1}^{N} {C}_{m , n} exp ( j ω {L}_{m , n} - \frac{1}{j ω {c}_{m , n}} )}{1 - {\sum }_{k = 1}^{N} {C}_{k , n} exp ( j ω {L}_{k , n} - \frac{1}{j ω {c}_{k , n}} ) {e}^{jkd sin θ}} ]}^{m - 1}$$

When d is very small, the array factor is uniform and there is no beam forming effect as expected. In the coupled array scenario where the array consists of identical SRR elements with the same external excitation field, Iₘₒ=Iₙₒ, the array factor becomes:

$$AF ( θ ) = {\sum }_{m = 1}^{M} {I}_{m 0} exp ( - j ( m - 1 ) ( kd sin θ + β ) )$$

Where after separating the amplitude and phase terms one finds:

$$\sum {C}_{m , n} exp ( j ω ( {L}_{m , n} + \frac{1}{{ω}^{2} {c}_{m , n}} ) ) = \sum {C}_{m , n} cos ( ω ( {L}_{m , n} + \frac{1}{{ω}^{2} {c}_{m , n}} ) ) + j \sum {C}_{m , n} sin ( ω ( {L}_{m , n} + \frac{1}{{ω}^{2} {c}_{m , n}} ) ) , \\ \sum {C}_{k , n} exp ( j ω ( {L}_{k , n} + \frac{1}{{ω}^{2} {c}_{k , n}} ) ) = \sum {C}_{k , n} cos ( ω ( {L}_{k , n} + \frac{1}{{ω}^{2} {c}_{k , n}} ) ) + j \sum {C}_{k , n} sin ( ω ( {L}_{k , n} + \frac{1}{{ω}^{2} {c}_{k , n}} ) )$$

In the scenario where the following conditions are met:

$$\sum {C}_{m , n} cos ( ω ( {L}_{m , n} + \frac{1}{{ω}^{2} {c}_{m , n}} ) ) >> \sum {C}_{k , n} cos ( ω ( {L}_{k , n} + \frac{1}{{ω}^{2} {c}_{k , n}} ) ) >> 1 , \sum {C}_{m , n} sin ( ω ( {L}_{m , n} + \frac{1}{{ω}^{2} {c}_{m , n}} ) ) >> \sum {C}_{k , n} sin ( ω ( {L}_{k , n} + \frac{1}{{ω}^{2} {c}_{k , n}} ) ) > kd sin θ + β ,$$

the transfer ratio can be approximated as:

$$\frac{\sum {C}_{m , n} cos ( ω ( {L}_{m , n} + \frac{1}{{ω}^{2} {c}_{m , n}} ) )}{\sum {C}_{k , n} cos ( ω ( {L}_{k , n} + \frac{1}{{ω}^{2} {c}_{k , n}} ) )} + j \frac{\sum {C}_{m , n} sin ( ω ( {L}_{m , n} + \frac{1}{{ω}^{2} {c}_{m , n}} ) )}{\sum {C}_{k , n} sin ( ω ( {L}_{k , n} + \frac{1}{{ω}^{2} {c}_{k , n}} ) )} = {A}_{m} exp ( j {ωΔ}_{m} ) ,$$

Where Aₘ and Δₘ show amplification in amplitude and phase, respectively. The amplification may occur because the coupling between the two elements may force them to respond oppositely to external excitations, where the two elements may behave like two “anti-parallel” dipoles, when on one may consider the two elements “asymmetrically” coupled. In the event of strong coupling, the array factor may be significantly amplified and may create a virtual large array behavior. The desired coupling amplitude and phase of the SRR array can be physically implemented by tuning SRR separation distances and loading Ls and Cs. The coupling amplitude and phase of SRRs can be computed through their mutual capacitance and inductance by:

$${c}_{m , n} = 2 πɛ a {\sum }_{n = 1}^{x} \frac{sinh ( ln ( d \text{/} a + \sqrt{{d}^{2} \text{/} {a}^{2} - 1} ) )}{sinh ( n ln ( d \text{/} a + \sqrt{{d}^{2} \text{/} {a}^{2} - 1} ) )}$$

$${L}_{m , n} = \frac{{μ}_{0}}{4 π} {∮}_{SRR 1} {∮}_{SRR 2} \frac{{dl}_{1} \cdot {dl}_{2}}{\vert r - {r}^{′} \vert}$$

$$\begin{matrix}a —dimension of SRR \\ d —adjacent SRR spacing\end{matrix}$$

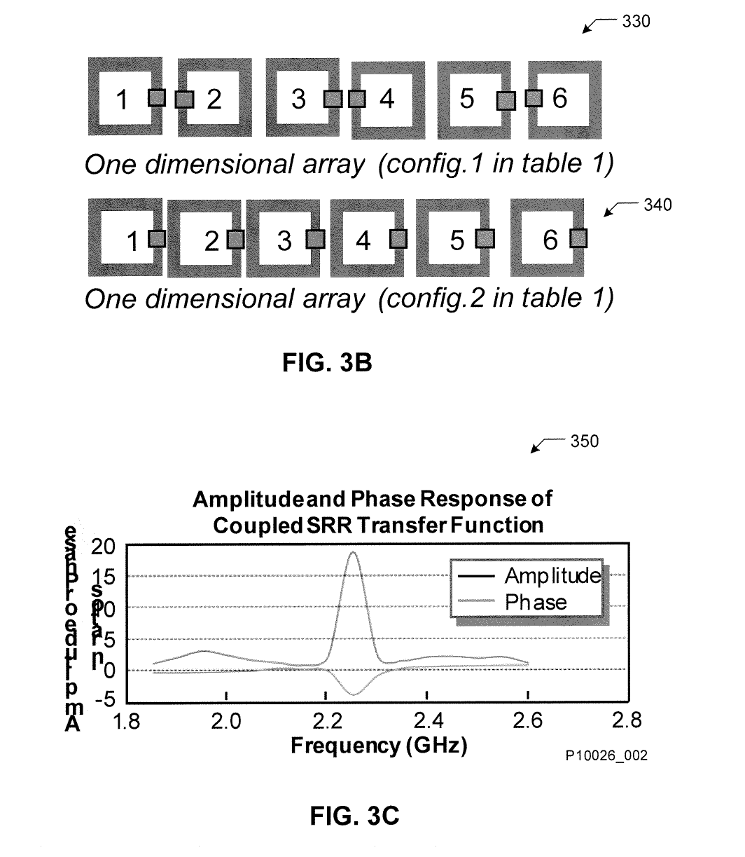

Substituting mutual capacitance and inductances as well as coupling factors into the above conditions may be required for generating virtual large array behavior:

$$\sum \frac{{Z}_{e , mn} - {Z}_{o , mn}}{{Z}_{e , mn} + {Z}_{o , mn}} cos ( ω ( \frac{{μ}_{0}}{4 π} {∮}_{1} {∮}_{2} \frac{{dl}_{1} \cdot {dl}_{2}}{\vert r - {r}^{′} \vert} + {( 2 {πɛ}^{3} a {\sum }_{n = 1}^{∞} \frac{sinh ( ln ( {d}_{m , n} \text{/} a + \sqrt{{d}_{m , n}^{2} \text{/} {a}^{2} - 1} ) )}{sinh ( n ln ( {d}_{m , n} \text{/} a + \sqrt{{d}_{m , n}^{2} \text{/} {a}^{2} -} ) )} )}^{- 1} ) ) >> \sum \frac{{Z}_{e , kn} - {Z}_{o , kn}}{{Z}_{e , kn} + {Z}_{o , kn}} cos ( ω ( \frac{{μ}_{0}}{4 π} {∮}_{3} {∮}_{4} \frac{{dl}_{1} \cdot {dl}_{2}}{\vert r - {r}^{′} \vert} + {( 2 {πɛ}^{3} a {\sum }_{n = 1}^{∞} \frac{sinh ( ln ( {d}_{m , n} \text{/} a + \sqrt{{d}_{m , n}^{2} \text{/} {a}^{2} - 1} ) )}{sinh ( n ln ( {d}_{m , n} \text{/} a + \sqrt{{d}_{m , n}^{2} \text{/} {a}^{2} - 1} ) )} )}^{- 1} ) ) >> 1 , \sum \frac{{Z}_{e , mn} - {Z}_{o , . mn}}{{Z}_{e , mn} + {Z}_{o , mn}} sin ( ω ( \frac{{μ}_{0}}{4 π} {∮}_{1} {∮}_{2} \frac{{dl}_{1} \cdot {dl}_{2}}{\vert r - {r}^{′} \vert} + {( 2 {πɛ}^{3} a {\sum }_{n = 1}^{∞} \frac{sinh ( ln ( {d}_{m , n} \text{/} a + \sqrt{{d}_{m , n}^{2} \text{/} {a}^{2} -} ) )}{sinh ( n ln ( {d}_{m , n} \text{/} a + \sqrt{{d}_{m , n}^{2} \text{/} {a}^{2} - 1} ) )} )}^{- 1} ) ) >> \sum \frac{{Z}_{e , kn} - {Z}_{o , . kn}}{{Z}_{e , kn} + {Z}_{o , kn}} sin ( ω ( \frac{{μ}_{0}}{4 π} {∮}_{3} {∮}_{4} \frac{{dl}_{1} \cdot {dl}_{2}}{\vert r - {r}^{′} \vert} + {( 2 {πɛ}^{3} a {\sum }_{n = 1}^{∞} \frac{sinh ( ln ( {d}_{m , n} \text{/} a + \sqrt{{d}_{m , n}^{2} \text{/} {a}^{2} -} ) )}{sinh ( n ln ( {d}_{m , n} \text{/} a + \sqrt{{d}_{m , n}^{2} \text{/} {a}^{2} - 1} ) )} )}^{- 1} ) ) >> kd sin θ + β ,$$

Where Zₑ and Zₒ correspond to even and odd impedances in magnitude between adjacent SRRs. Impedances Zₑ and Zₒ may be direct functions of SRR parameters such as SRR spacing, orientation, loading capacitance, and inductance and can be computed analytically using network theory. By tuning these SRR parameters, the above condition for large virtual array can be met while keeping the frequency of operation the same. Below, with respect to table 300 of FIG. 3, examples for two potential designs of simple one-dimensional arrays, where virtual large array behavior can be realized, are discussed. Going back to the Ormia example, the transfer function of the female Ormia due to coupling effect can be shown as:

$$\frac{D ( j ω ) exp ( - j ( ωΔ + β ) ) - N ( j ω )}{D ( j ω ) - N ( j ω ) exp ( - j ( ωΔ + β ) )}$$

which exhibits virtual large array behavior through strong amplification over amplitude and phase response ratio as shown in FIGS. 1B-1C. Compare this transfer function with that of the SRR arrays derived above:

$$\frac{{I}_{mo} {e}^{jkd sin θ} - {I}_{m 0} {\sum }_{n = 1}^{N} {C}_{m , n} exp ( j ω {L}_{m , n} - \frac{1}{j ω {c}_{m , n}} )}{{I}_{no} - {I}_{n 0} {\sum }_{k = 1}^{K} {C}_{k , n} exp ( j ω {L}_{k , n} - \frac{1}{j ω {c}_{k , n}} ) {e}^{jkd sin θ}}$$

The two expressions are very similar in form and characteristics. Coupled SRR antenna array (e.g., ESA arrays 210, 220, and 230 of FIG. 2A-2C) may be one form of implementation of the biological Ormia ears in phased array antennas. The similar coupling mechanism forces the two antenna elements to behave like two “anti-parallel” dipoles with opposite phase and amplitude response.

FIGS. 3A-3C show a table 300 illustrating example design parameters for a one-dimensional beam forming ESA array 210 of FIG. 2A, design configurations 330 and 340, and response functions 350, according to certain aspects. Table 300 lists the design parameters for two design configurations. For both configurations 330 and 340, strong coupling may exists between adjacent SRRs (e.g., ESA element 212 and 213 of FIG. 2A). For the first configuration 330, the coupling factor 310 for each neighboring pair may vary periodically in both amplitude and phase along the array direction (e.g., x in FIG. 2A). The periodic variation may be enabled by alternate capacitive coupling and inductive coupling between two adjacent neighbors. The separation between any adjacent neighbors is kept the same.

For the second configuration 340, the coupling factor 310 for each neighboring pair may vary monotonically along the array direction (e.g., x in FIG. 2A) in both amplitude and phase. The variation may be enabled by varying spacing between two neighboring elements monotonically in the array direction. For both configurations, the varying coupling factors along the array physically set up a virtual array of “anti-parallel” dipoles. The amplification from each adjacent pair multiplies constructively along the array, thus enabling very large array factor.

FIG. 3C show a response function 350 that plots the amplitude and phase response in ratios for the coupled SRR arrays corresponding to the example design 330 and 340 of FIG. 3B, which are computed analytically. Strong amplifications is observed near a resonance frequency (e.g., ˜2.25 GHz), where the coupled SRR arrays operate and couple to each other. The amplification is very similar to the response function of Ormia's ears (see FIGS. 1B and 1C). Note that the ratio of the values of the diagrams shown in FIGS. 1B and 1C may correspond to response function 350, because the diagrams shown in FIGS. 1B and 1C correspond to two ears of Ormia individually and not to the ratio of the responses of the two ears. As seen from the response functions 350, the amplification mechanism in both amplitude and phase transforms a small SRR array to behave like a large aperture array.

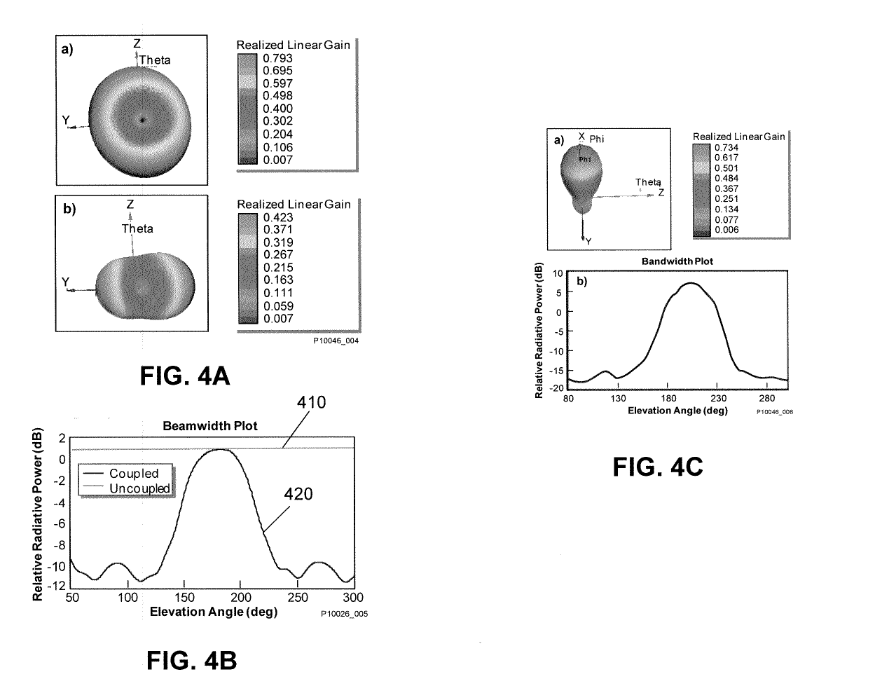

FIGS. 4A-4C show diagrams illustrating example radiation patterns in 3D and 2D plots for one and two-dimensional beam forming ESA arrays, according to certain aspects. A one-dimensional coupled SRR array (e.g., 210 of FIG. 2A) with optimized coupling map was simulated. In terms of configuration the simulated array was very similar to that shown in configuration 340 of FIG. 3B. The inter-ring distances may be within the range of 0.04 to 0.2 mm and may increase monotonically along the array direction. FIG. 4A compares the radiation pattern for the coupled array (b) versus that of an uncoupled array (a). For the uncoupled array simulation, the inter-ring spacings are set to 0.6 mm uniformly across the array such that the coupling coefficient becomes negligibly small (≦−50 dB) and the SRRs can be considered totally de-coupled. It is observed that, in the absence of coupling, no beam forming may be achieved, and the corresponding radiation characteristics (a) shows omni-directional radiative pattern, which is typical of small uncoupled ESA arrays. For the coupled ESA array, however, a very distinctive one-dimensional beam forming characteristics is observed, which is similar to that of a large aperture array. FIG. 4B plots the power pattern as a function of elevation angle for an azimuth cut at θ=90°. As expected, uncoupled array exhibits an omni-directional pattern 410. In comparison, the coupled array exhibits a one-dimensionally confined narrow beam pattern 420. The 3-dB beam width in beam pattern 420 is less than 80° and the sidelobe level are seen to be less than −11 dB.

A two-dimensional coupled SRR array (e.g., 220 of FIG. 2B) was simulated and optimized in its coupling map for best directivity. The optimized coupling map may vary from high-low-high-low in both dimensions, in a fashion similar to first configuration of Table 300, shown in diagram 330 of FIG. 3B. For each SRR, the two immediate neighbors from each side may have different reactive coupling mechanisms. One side may have a capacitive coupling and the other side may include inductive coupling. The two types of reactive coupling form the high-low-high-low map in both amplitude and phase. FIG. 4C plots the radiation patterns for the optimized array in 3D and 2D formats at an azimuthal plane at θ=90°. The radiative pattern (a) shows a very narrow two-dimensionally confined beam formed with very low side-lobe levels. The 3-dB beam width is seen to be less than 50 degrees and the side-lobe level are less than −20 dB. As expected, significant improvement in performance from the two-dimensional array over that from the one-dimensional array is observed.

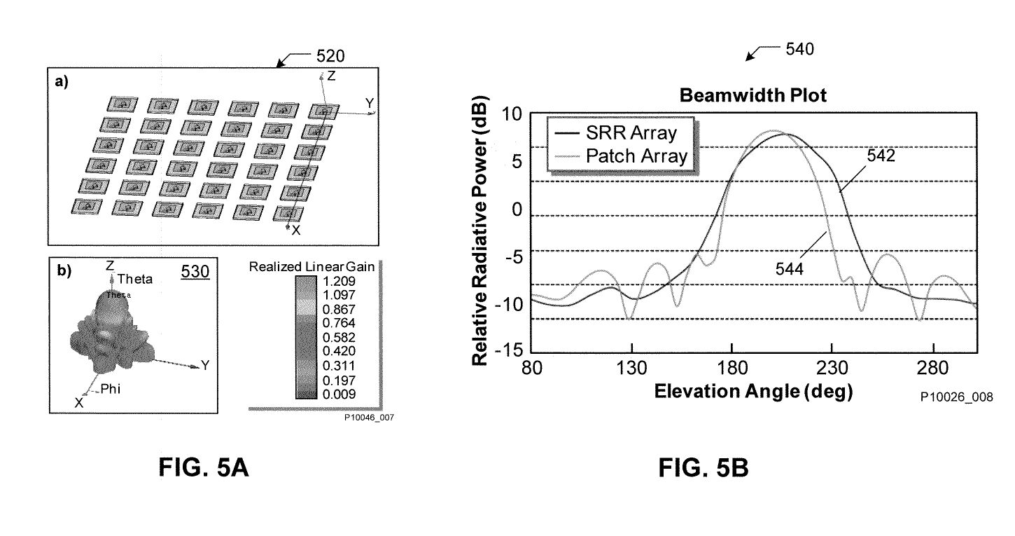

FIGS. 5A-5B are diagrams illustrating an example conventional patch antenna array 520 and corresponding 3D radiation pattern 530, and 2D radiation pattern plots 540, according to certain aspects. A simulation result corresponding to a conventional patch antenna array 520 operating at the same frequency as the previously described 2D SRR array is shown (see 530 and 540). FIG. 5 A shows a 36 element (6×6) patch array 520 and its corresponding radiation pattern 530. The inter-elemental spacing is set to λ/2 and the dimension of each patch is λ/2×λ/2 (e.g., λ=7 cm). The size of the patch array is therefore 38.5×38.5 cm. Strong undesired sidelobes are visible in radiation pattern 530. A normalized power pattern comparison between the patch array 520 and a two-dimensional coupled SRR array in 2D plane at azimuth cut θ=90° is shown in FIG. 5B. The SRR array 542 exhibits similar beamwidth but less sidelobes (˜3 dB less) as compared to result 544 for patch array 520. The SRR array show better beam forming capability yet at much smaller footprint of 3×2 cm in size, which represents ˜100 times reduction in area. The SRR array may be optimized to achieve even narrower beamwidth.

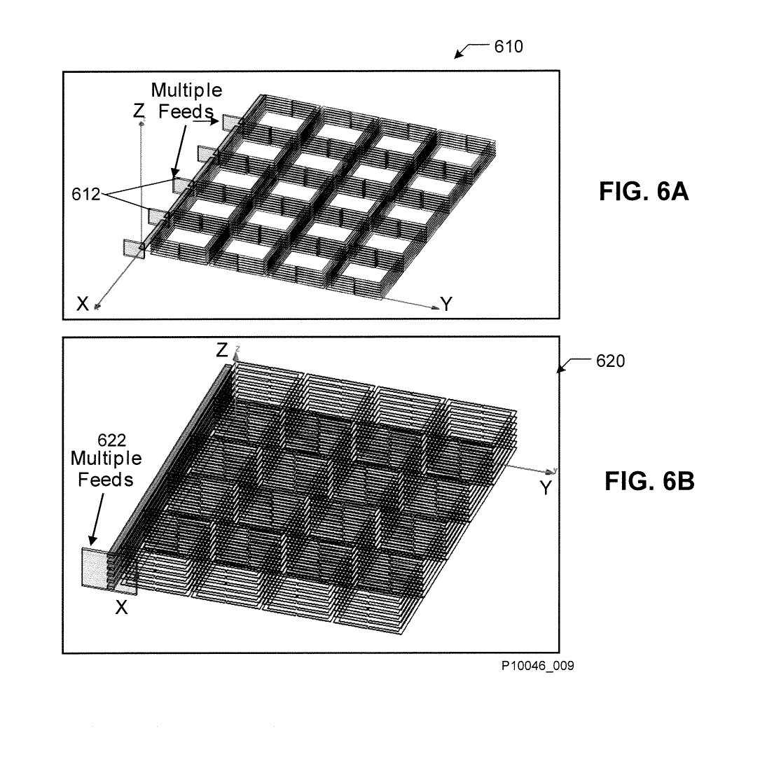

FIGS. 6A-6B are diagrams illustrating example active beam forming with multiple excitation antennas, according to certain aspects. The beam forming capability of one- and two-dimensional coupled SRR arrays have been demonstrated above through numerical simulations. According to some aspects of the subject technology, three-dimensional arrays and active beam forming may realize even higher directivity ESA arrays. Three-dimensional coupled SRR arrays with single-feed can be designed using similar coupling maps as those used in one- and two-dimensional single-feed arrays. Three-dimensional arrays may offer additional degrees of freedom to further improve/optimize their radiation performance. After passive beam forming capability is fully exploited in coupled SRR arrays, further enhancement in directivity can be accomplished by active beam forming through multiple feeds.

Various ways to implement multiple feeds are possible for the SRR arrays. FIG. 6A-6B illustrate two example implementations. In one configuration, multiple excitation antennas 612 may be aligned in series, with each excitation antenna controlling a group of ESA array elements in IS plane. In another configuration, multiple excitation antennas 622 may be aligned in parallel (e.g., on the top of each other in the Z direction), with each excitation antenna controlling a group of ESA array elements in the XY plane. Each configuration may have its own merit depending on the application requirements. Numerical simulations may be used to determine the optimum number of required excitation antennas and corresponding weight assignments.

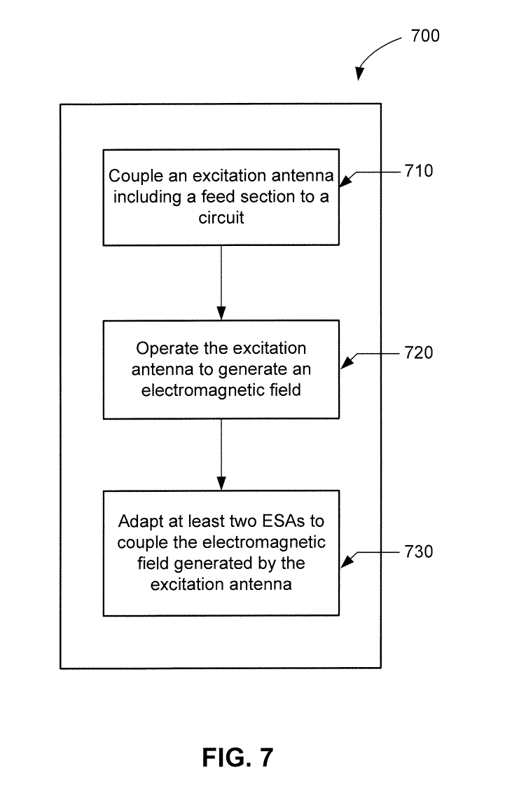

FIG. 7 is a flow diagram illustrating an example method 700 for electromagnetic beam forming, according to certain aspects. Method 700 may begin at operation 710, where an excitation antenna (e.g., 214 of FIG. 2A) including a feed section (e.g., 215 of FIG. 2A) is coupled to an external circuit. The excitation antenna may be operated to generate an electromagnetic field (operation 720). At least two ESAs (e.g., 212 and 213 of FIG. 2A) may be adapted to couple the electromagnetic field generated by the excitation antenna (operation 720). The electromagnetic field may be created as a result of a current generated by the induction coupling.

In some aspects, the subject technology, electrically small and broadband antenna phased arrays find applications in numerous industries, such as defense, communication, and electronics. Those antenna arrays are the building blocks for next-generation future engineering platforms with low SWaP (size, weight, and power), especially for tactical and mobile applications. The markets for the subject technology may include, but is not limited to, defense communication industries, electronic PC companies, and wireless communication industry.

The description of the subject technology is provided to enable any person skilled in the art to practice the various aspects described herein. While the subject technology has been particularly described with reference to the various figures and aspects, it should be understood that these are for illustration purposes only and should not be taken as limiting the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various aspects described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the invention has been described with reference to the disclosed aspects, one having ordinary skill in the art will readily appreciate that these aspects are only illustrative of the invention. It should be understood that various modifications can be made without departing from the spirit of the invention. The particular aspects disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative aspects disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range is specifically disclosed. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is:

1. An apparatus for beam forming of electromagnetic waves using electrically small antenna (ESA) elements, the apparatus comprising:
an excitation antenna including a feed section coupled to a circuit; and
at least two ESAs adapted to couple to the excitation antenna,
wherein 1) coupling to the excitation antenna comprises electromagnetic coupling,
2) the excitation antenna is operable to generate an electromagnetic field that couples to the at least two ESAs, and 3) the electromagnetic field is created as a result of a current generated by an induction coupling.

2. The apparatus of claim 1, wherein the excitation antenna is operable to provide a current to the circuit as a result of coupling to an electromagnetic field generated by the at least two ESAs when the apparatus operates as a receiver antenna, and wherein the circuit is an external circuit.

3. The apparatus of claim 2, wherein the ESA comprises a split ring resonator (SRR), wherein the SRR comprises a ring made of an electrically conducting ring including a slit having a predetermined gap, and wherein a spacing between the at least two ESAs is less than approximately 0.5 mm.

4. The apparatus of claim 2, wherein the SRR is configured as a flat ring having at least one of a square, rectangular or circular shape, wherein a diameter of the ring is a predetermined fraction of a wavelength corresponding to a resonance frequency of the SRR, and wherein the predetermined fraction is approximately five percent.

5. The apparatus of claim 1, wherein the at least two ESAs are operable to provide electromagnetic inter-coupling between at least some of two adjacent ESAs, and wherein electromagnetic inter-coupling depends on at least one of the distance between the two adjacent ESAs, loading capacitances, or loading inductances.

6. The apparatus of claim 5, wherein desired beam forming features of the apparatus are achieved through adjusting the electromagnetic inter-coupling between the at least some of two adjacent ESAs, and wherein adjusting the electromagnetic inter-coupling includes adjusting a phase and an amplitude of the electromagnetic inter-coupling.

7. The apparatus of claim 1, further comprising additional excitation antennas, wherein each excitation antenna is adapted to electromagnetically couple to at least one ESA, wherein the additional excitation antennas are operable to facilitate active beam forming.

8. The apparatus of claim 1, wherein the at least two ESAs comprise at least one of a two-dimensional or three-dimensional array of ESAs.

9. The apparatus of claim 8, wherein the three-dimensional array comprises a plurality of two-dimensional arrays formed on the top of each other, and wherein the spacing between the two-dimensional arrays is formed by a laminate layer.

10. The apparatus of claim 9, wherein the ESAs of the three-dimensional array are coupled to multiple excitation antennas, wherein the multiple excitation antennas comprise excitation antennas configured in at least one of two configurations, wherein in a first configuration, the multiple excitation antennas are operable in series, and in a second configuration, the multiple excitation antennas are operable in parallel.

11. The apparatus of claim 10, wherein the at least two ESAs comprise one or more wide band ESAs, wherein each wide band ESA comprises a sub-array having a size of the order of approximately one-tenth of the wavelength corresponding to the resonance frequency of the sub-array.

12. The apparatus of claim 11, wherein the sub-array comprises a two-dimensional (2-D) array of slit-ring resonators (SRRs), and wherein the 2-D array of SRRs operate at a number of different frequencies.

13. The apparatus of claim 1, wherein the at least two ESA and the excitation antenna are formed on a printed circuit board (PCB).

14. A method for electromagnetic beam forming using electrically small antenna (ESA) elements, the method comprising:
coupling an excitation antenna including a feed section to a circuit;
operating the excitation antenna to generate an electromagnetic field; and
adapting at least two ESAs to couple the electromagnetic field generated by the excitation antenna,
wherein the electromagnetic field is created as a result of a current generated by an induction coupling.

15. The method of claim 14, wherein the plurality of sensor arrays are adapted to collect images at video rates and the method is adapted for use in stellar interferometry and intensity correlation interferometry.

16. The method of claim 14, wherein the ESA comprises a slit-ring resonator (SRR), wherein the SRR comprises a ring made of an electrically conducting ring including a slit having a predetermined gap, and wherein the method further comprises configuring the SRR as a flat ring having at least one of a square, rectangular or circular shape, wherein a diameter of the ring is a predetermined fraction of a wavelength corresponding to an resonance frequency of the SRR, and wherein the predetermined fraction is approximately five percent.

17. The method of claim 14, further comprising providing electromagnetic inter-coupling between at least some of two adjacent ESAs, and wherein electromagnetic inter-coupling depends on at least one of the distance between the two adjacent ESAs, loading capacitances, or loading inductances.

18. The method of claim 17, further comprising adjusting the electromagnetic inter-coupling between the at least some of two adjacent ESAs to achieve desired beam forming features, and wherein adjusting the electromagnetic inter-coupling includes adjusting a phase and an amplitude of the electromagnetic inter-coupling.

19. The method of claim 14, further comprising:
adapting additional excitation antennas to electromagnetically couple to at least one ESA;
facilitating active beam forming by operating the additional excitation antennas;
coupling the ESAs of a three-dimensional array to multiple excitation antennas, and
configuring the multiple excitation antennas in at least one of two configurations, wherein in a first configuration, the multiple excitation antennas are operable in a series configuration, and in a second configuration, the multiple excitation antennas are operable in parallel configuration.

20. The method for claim 14, wherein adapting the coupling to the electromagnetic field generated by the excitation antenna comprises adapting one or more wide band ESAs, wherein each wide band ESA comprises a sub-array having a size of the order of approximately one-tenth of the wavelength corresponding to the resonance frequency of the sub-array, wherein the sub-array comprises a two-dimensional (2-D) array of slit-ring resonators (SRRs), and wherein the 2-D array of SRRs operate at a number of different frequencies, and further comprising forming the at least two ESAs and the excitation antenna on a printed circuit board (PCB).
